(19) United States
(12) Patent Application Publication
(10) Pub. No.: US 2024/0258781 A1
(43) Pub. Date: Aug. 1, 2024

(54) CONNECTION DEVICE FOR MULTI-WIRE ELECTRICAL CABLE AND ASSOCIATED COMPLEMENTARY DEVICES

(71) Applicant: Schneider Electric Industries SAS, Rueil Malmaison (FR)

(72) Inventors: Dominique Masse, Epinay sur Orge (FR); Sylvain Briole, Meylan (FR); Bruno Peccoud, Grenoble (FR); Franck Megret, Montchaboud (FR)

(73) Assignee: Schneider Electric Industries SAS, Rueil Malmaison (FR)

(21) Appl. No.: 18/408,734

(22) Filed: Jan. 10, 2024

(30) Foreign Application Priority Data
Feb. 1, 2023 (FR) 2300933

(51) Int. Cl. H02G 3/16; H01R 4/2416; H02G 3/04

(52) U.S. Cl. CPC H02G 3/16; H01R 4/2416; H02G 3/0468

(57) ABSTRACT

A connection device, for connecting a multi-wire electrical cable to a complementary module. The connection device includes a main portion, which forms a guide passage for one end of the cable, and a holding portion, which is fixed to the main portion. The holding portion includes guide paths, each of which is configured to receive a respective wire of the cable, so as to hold the corresponding wire in a predetermined position relative to the holding portion, where the wires are accessible along a connection direction. The connection device is configured to cooperate with the complementary module by bringing the complementary module closer to the connection device in a connecting movement parallel to the connecting direction, so as to connect the complementary module to the wires received in the guide paths.

### TECHNICAL FIELD

The present invention concerns a connection device for multi-wire electrical cable, an assembly piece configured to cooperate with a connection device of this kind, an electrical connection box including an assembly piece of this kind, a connection socket including an electrical connection box of this kind and a connection device of this kind, a complementary module configured to be assembled to a connection socket of this kind, and an electrical connection assembly including an electrical connection socket of this kind and a complementary module of this kind.

### BACKGROUND

Buildings are generally equipped with networks of multi-wire cables for transporting electrical energy and/or data. Examples of multi-wire cables commonly used in buildings include so-called “Ethernet” cables that comprise a plurality of twisted wire pairs and electrical power cables generally comprising three wires, that is to say a live wire, a neutral wire and an earth wire.

The cables are generally concealed inside partitions, generally in the walls, of the building, for example in trunking accommodated in the partitions, and one end of these cables terminates at the level of electrical connection boxes fixed to these partitions, generally flush-fitted in the partitions. These connectors, generally of female type, are fixed to the ends of the cables. For example, these connectors are a female electrical socket, a so-called “RJ45” female connector, etc. For each multi-wire cable the installer has to strip each wire, connect and secure each wire to the corresponding connector, and then fix the connector in the corresponding electrical connection box, each of these operations taking some time. Furthermore, in the event of a poor connection the installer often has no other choice than to start over the entire operation of fitting the connector to the end of the cable.

### SUMMARY

It is these problems that the invention is more particularly intended to remedy, by proposing a connection device for multi-wire electrical cable that is easier and faster to connect to the cable.

To this end, the invention concerns a connection device for connecting a multi-wire electrical cable to a complementary module.

In accordance with the invention, the connection device includes:
a main portion that forms a passage configured to guide an end of the cable, the passage including a main duct that opens to the outside of the main portion,
a retaining portion that is secured to the main portion and configured to position the end of the cable emerging from the passage,

in which:
the retaining portion includes one or more guide paths each of which is configured to receive a respective wire of the cable in such a manner as to retain the corresponding wire in a predetermined position relative to the retaining portion,
each guide path includes a connection portion that extends parallel to the same connection plane as the retaining portion,
the connection portions are arranged in such a manner as to allow access to each wire received in the corresponding connection portion in a connection direction orthogonal to the connection plane,
the connection device is configured to cooperate with the complementary module by moving the complementary module of the connection device closer by a connection movement parallel to the connection direction, in such a manner as to connect the complementary module to each of the wires received in the corresponding connection portion, the retaining portion being in a connection position relative the main portion.

Thanks to the invention, each wire of the cable is received in a corresponding guide path, which renders the placing of the wires systematic and prevents errors. Once the wires have been put into place and secured, when the connection device is in the connection configuration, the complementary module is connected to each of these wires by a single movement in translation. The complementary module advantageously includes insulation-displacement connectors. The connection of the complementary module to the wires retained by the connection device is simple, rapid and free of the risk of errors.

In accordance with advantageous but not obligatory aspects of the invention, a connection device of this kind may incorporate one or more of the following features separately or in any technically permissible combination:
Each connection portion is configured to cooperate with a respective connector of the complementary module, in particular an insulation-displacement connector, in such a manner as to connect electrically each wire received in the corresponding connection portion to the corresponding complementary connector by movement in translation in the connection direction.
The main portion includes an immobilising device that is configured to clamp the cable when the cable is received in the passage in such a manner as to prevent movement of the cable along the passage.
The main portion is configured to be fixed to one end of a protective sheath of the cable, the passage being in line with the sheath.
The main portion is configured to be fixed to one end of a ringed sheath comprising rings,
and the main portion includes clipping members that are configured to cooperate with the rings of the sheath in such a manner as to fix the main portion to the sheath.
The retaining portion is mobile in rotation relative to the main portion between:
   a mounting position in which the retaining portion does not prevent longitudinal movement of the cable in the passage, and
      the connection position in which the connection portions are able to retain each wire in order to connect each wire to the complementary module.
The main duct is configured to receive a cable comprising four pairs of wires, in particular a cable of Ethernet type as defined in the standard IEEE 802.3, and
the retaining portion includes a central orifice that extends the main duct when the retaining portion is in the mounting position and that is at an angle to the main duct when the retaining portion is in the connection position so as to guide the cable received in the main duct and the central orifice with a radius of curvature greater than 3 mm.
The connection portions are arranged radially relative to a central axis of the central orifice.
The passage includes, in addition to the main duct, at least one secondary duct, each main or secondary duct being configured to receive a respective wire of the cable,
the retaining portion includes a plurality of guide paths each of which is associated with a respective duct and that are arranged parallel to one another, and
the connection portions are parallel to the main duct when the retaining portion is in the connection position.

The invention also concerns an assembly piece configured to form a back of an electrical connection box, the assembly piece including at least one housing, preferably two housings, the or each housing being configured to cooperate, in particular by complementarity of shape, with a respective connection device, each connection device being as described above, so as to retain each connection device in the connection configuration.

The assembly piece advantageously further includes retaining members that are configured to cooperate, in particular by complementarity of shape, with the main portion of each connection device so as to retain that connection device in position relative to the assembly piece.

The invention also concerns an electrical connection box including a housing configured to be fixed to a partition and an assembly piece as described above, the assembly piece forming a back of the housing.

Advantageously:
The assembly piece is attached to the rest of the housing.
The assembly piece is made in one piece with the rest of the housing.

The invention also concerns a connection socket that includes:
a connection box as described above, and
at least one connection device as described above, each connection device being associated with a respective housing of the assembly piece.

in which:
each retaining portion is received in a respective housing of the assembly piece, each connection device being retained in the connection configuration,
the connection direction is orthogonal to the back of the housing.

Another aspect of the invention concerns a complementary module configured to be assembled onto a connection socket as described above, in which:
the complementary module includes a mounting portion configured to be inserted in the housing in a movement in translation orthogonal to the back of the housing,
the mounting portion has a lower face on which are disposed connectors, preferably insulation-displacement connectors,
each connector is arranged in such a manner as to cooperate with a respective connection portion when the complementary module is inserted in the housing by the movement in translation so that when a wire is received in that connection portion the corresponding connector is electrically connected to that wire.

The invention finally concerns an electrical connection assembly including:
a connection socket as described above,
a complementary module as described above, in which the complementary module is inserted in the connection socket.

### BRIEF DESCRIPTION OF THE DRAWINGS

The invention will be better understood and other advantages thereof will become more clearly apparent on reading the following description of embodiments of a connection device for multi-wire electrical cable, an assembly piece, an electrical connection box, a connection socket, a complementary module and an electrical connection assembly in accordance with the principle thereof, which description is given by way of example only with reference to the appended drawings, in which:

FIG. 1: represents, in two inserts a) and b), an electrical connection assembly conforming to a first embodiment of the invention, respectively represented mounted on a partition and on its own, the connection assembly including a connection socket and a module complementary to that socket, both also conforming to the first embodiment of the invention;

FIG. 2: represents, in two inserts a) and b), two partially exploded perspective views of the connection assembly from FIG. 1, as seen from two different directions;

FIG. 3: represents, in three inserts a), b) and c), steps of assembling a connection device of the connection assembly from FIG. 1, the connection device conforming to a first embodiment of the invention;

FIG. 4: represents, in two inserts a) and b), steps of assembling the connection device from FIG. 3 to a casing of the connection socket from FIG. 1;

FIG. 5: respectively represents, in three inserts a), b) and c), a perspective view of the complementary module from FIG. 1 and details of the complementary module shown to a larger scale;

FIG. 6: represents, in three inserts a), b) and c), steps of assembling a connection device of the connection assembly from FIG. 1, the connection device conforming to a second embodiment of the invention;

FIG. 7: represents, in three inserts a), b) and c), steps of assembling the connection device from FIG. 6, to an Ethernet-type cable;

FIG. 8: respectively represents, in two inserts a) and b), a connection socket conforming to an alternative embodiment of the invention and a complementary module of that connection socket;

FIG. 9: respectively represents, in two inserts a) and b), a connection socket conforming to another alternative embodiment of the invention and a complementary module of that connection socket;

FIG. 10: respectively represents, in two inserts a) and b) complementary modules conforming to alternative embodiments of the invention;

FIG. 11: respectively represents on two inserts a) and b), a partially exploded perspective view of an electrical connection assembly conforming to an alternative embodiment of the invention, that electrical connection assembly comprising an electrical connection socket and a complementary module, and a front view of the electrical connection socket from insert a), and

FIG. 12: respectively represents, in two inserts a) and b), a perspective view of an electrical connection box of the electrical connections socket from FIG. 11 and a connection device of the electrical connection socket from FIG. 11.

### DETAILED DESCRIPTION

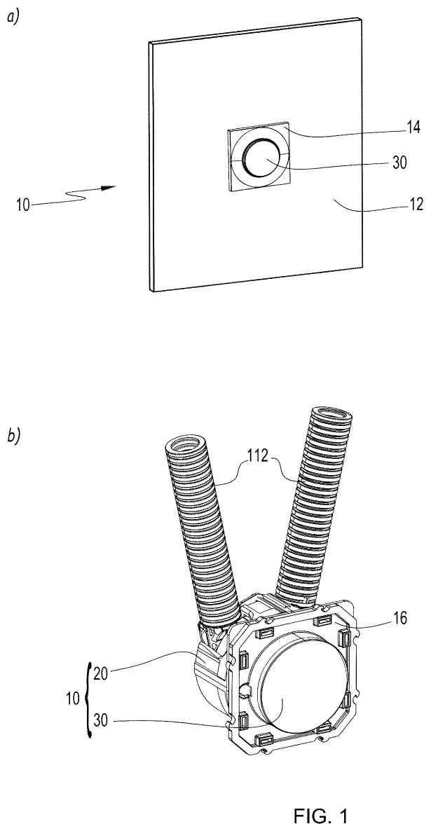

An electrical connection assembly 10 conforming to a first embodiment of the invention is represented in FIG. 1. In insert a) the connection assembly 10 is represented fixed to a partition 12, here a sheet of plasterboard. In particular, only a portion of the connection assembly 10 projects from the partition 12, the connection assembly 10 being flush-mounted in the partition 12. The partition 12 is assumed to be plane and vertical. The following description relates to the orientation of the various components of the connection assembly 10 as represented in the figures, knowing that this could be otherwise in reality.

The partition 12 is not represented in insert b). The connection assembly 10 comprises a connection socket 20 and a complementary module 30, which as represented here is inserted in the connection socket 20. The connection assembly 10 is in a connected configuration.

In insert a) the connection socket 10 is concealed by an embellisher 14 and the complementary module 30 emerges from a central hole in the embellisher 14. The embellisher 14 is assembled to the rest of the connection socket 20 by means of a base 16 visible in FIG. 1b). The embellisher 14 is preferably assembled to the base 16 by clipping it thereto, in such a manner as to facilitate mounting it and, if necessary, demounting it.

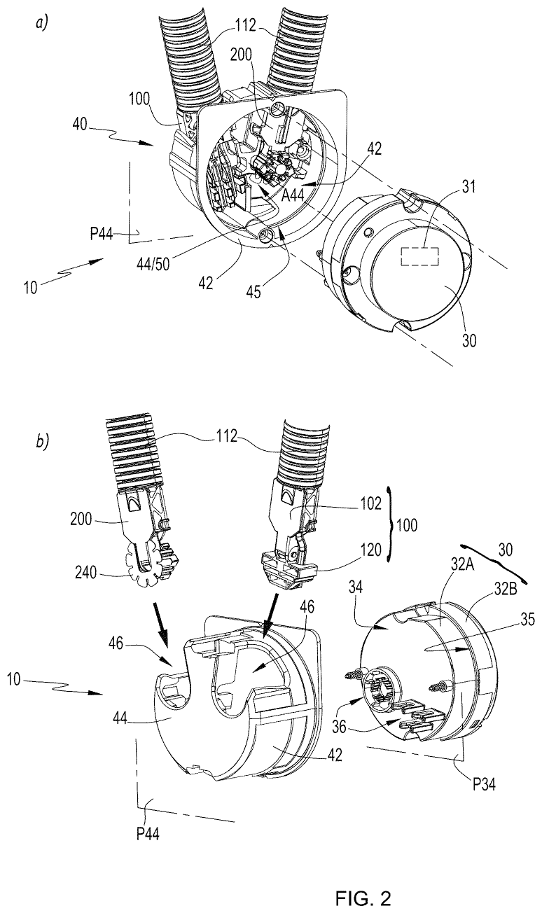

In FIG. 2 the connection assembly 10 is represented in a partially exploded perspective view, the complementary module 30 being situated at a distance from the connection socket 20, revealing the interior of the connection socket 20. The complementary module 30 is in a configuration for connection to the connection socket 20, that is to say—as described below—the complementary module 30 can be connected to the connection socket 20 by a connection movement, that is to say by moving the complementary module 30 closer to the connection socket 20 by a movement in translation and inserting the complementary module 30 in the connection socket 20.

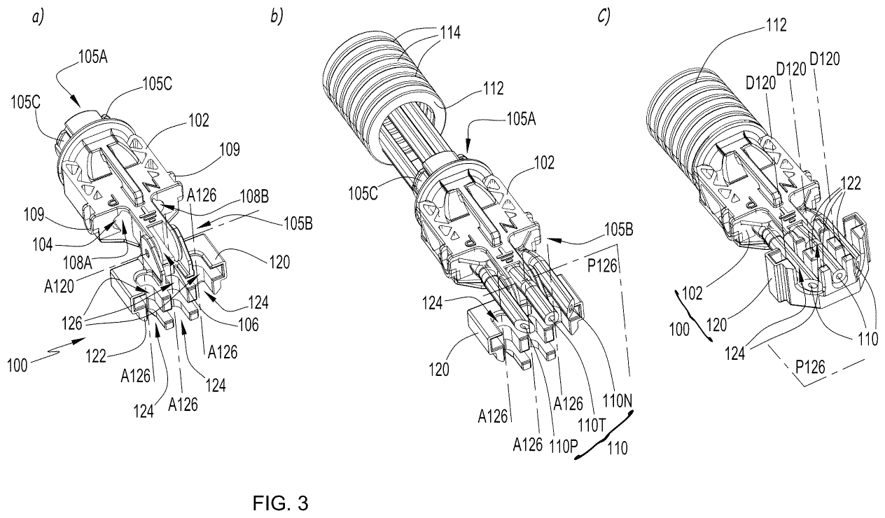

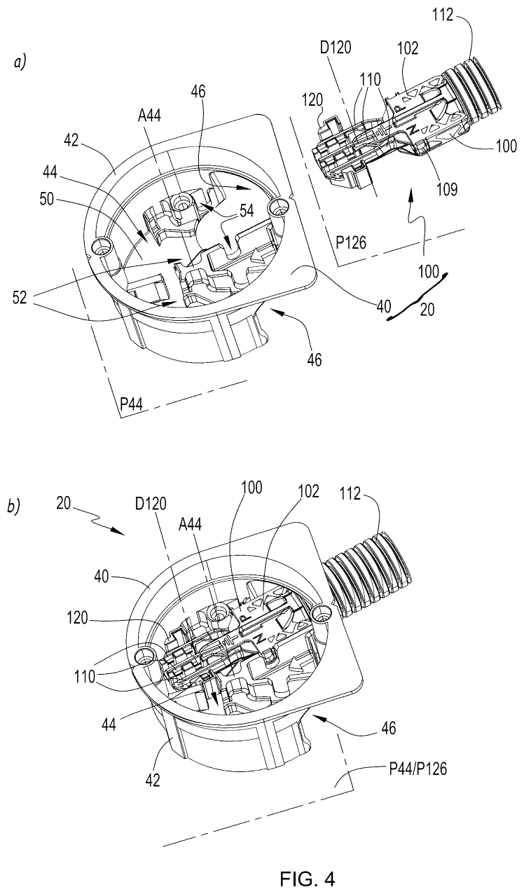

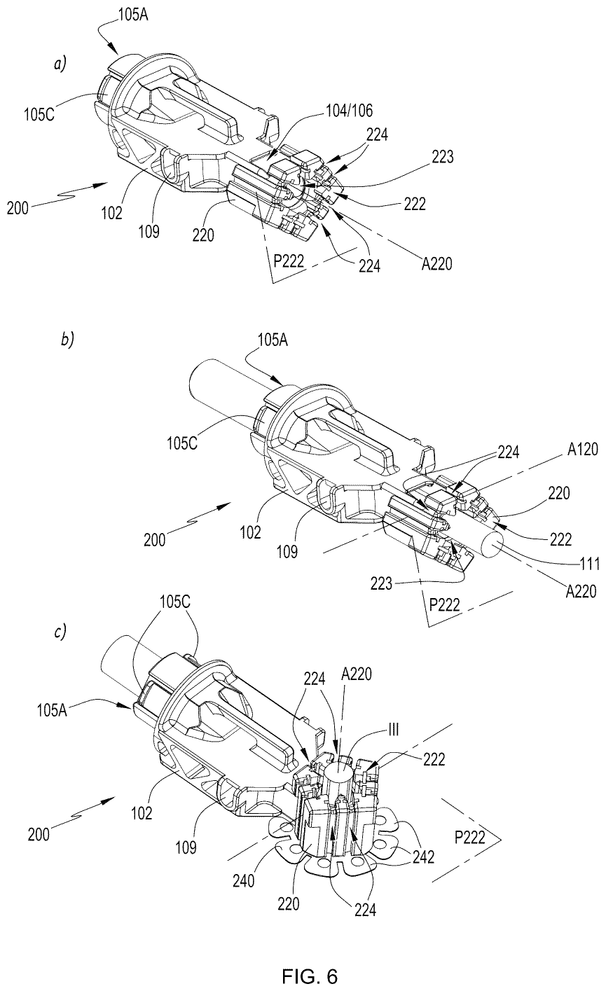

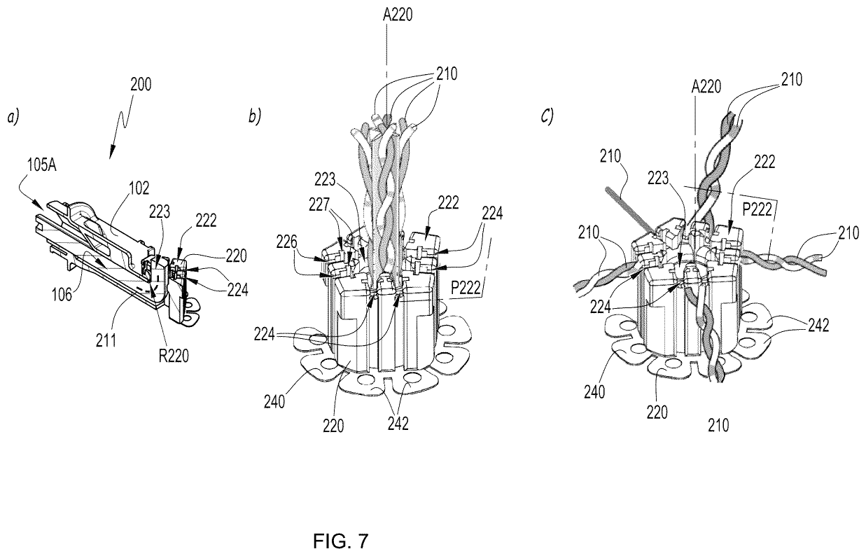

The connection socket 20 includes an electrical connection box 40 onto which at least one connection device is assembled. In the example depicted the connection socket 20 includes two connection devices of two different types that correspond to two different embodiments. A connection device 100 of the first type, corresponding to the first embodiment, is represented in FIGS. 3 and 4 while a connection device 200 of the second type, corresponding to the second embodiment, is represented in FIGS. 6 and 7. The connection device 100 of the first type is designed for connection to a power cable (also referred to as an “electrical cable”) while the connection device 200 of the second type is designed for connection to an Ethernet cable (comprising two or four pairs of wires), that is to say conforming to the standard IEEE 802.3 promulgated by the Institute of Electrical and Electronics Engineers. The connection device 200 is advantageously designed for connection to an Ethernet cable including an electrical power (Power over Ethernet (POE)) connection, conforming for example to one of the standards IEEE 802.3af, IEEE 802.3at or IEEE 802.3bt. The connection device 200 is also designed for connection to an Ethernet cable with a single twisted pair including an electrical power (Power over Data Lines (PoDL) for single twisted pair Ethernet) connection, for example conforming to the standard IEEE 802.3bu.

The connection devices 100, 200 are represented connected to the connection box 40 in FIG. 2a) and at a distance from the connection box 40 in FIG. 2b).

Each connection device 100, 200 is associated with a respective multi-wire cable; in particular each connection device 100, 200 is fixed to one end of that cable. Each connection device 100, 200 is configured to secure the wires of the corresponding cable so that they are immobile relative to the connection box 40 so as to facilitate connection of the complementary module 30 by the connection movement.

The connection box 40 includes a hollow housing 42 that forms a volume V42 to receive the complementary module 30. The housing 42 is configured to be fixed to the partition 12, for example by means of screws or some other equivalent fixing means. The housing 42 has a back 44 that is globally flat and extends in a back plane P44. When the connection box 40 is fixed to the partition 12 the back plane 44 is substantially parallel to the partition 12. The housing 42 has a globally cylindrical shape, here with a globally circular section centred on an engagement axis A44. The engagement axis A44 is therefore orthogonal to the back 44 of the housing. During insertion of the complementary module 30 into the connection box 40 the connection movement is parallel to the engagement axis A44, in other words orthogonal to the back 44 of the housing 42.

Here the complementary module 30 encloses a monitoring unit 31 schematically represented in dashed outline. As appropriate, the monitoring unit 31 includes an electronic circuit card with one or more microprocessors, one or more memories, one or more wireless communication means, etc. The complementary module 30 includes a mounting portion 32A that is configured to be inserted in the housing 42. In the example depicted here the complementary module 30 has an external portion 32B that projects from the housing 42 when the mounting portion 32A is received in the housing 42. In a variant that is not depicted the complementary module 30 does not project from the housing 42 when the mounting portion 32A is received in the housing 42.

The mounting portion 32A has a lower face 34 that is arranged to face the back 44 of the housing 42 when the complementary module 40 is connected to the connection socket 20, in other words when the connection assembly 10 is in the connected configuration. Here the lower face 34 is globally flat and extends in a lower plane P34. The mounting portion 32A has a globally cylindrical shape of circular section centred on a back axis A44 that is orthogonal to the plane P34. In the connected configuration of the connection assembly 10 the lower plane P34 Is preferably parallel or substantially parallel to the back plane P44; in other words the engagement axis A44 is orthogonal to the lower plane P34. By “substantially parallel” is meant parallel to within +/−5°. The complementary module 30 also includes connectors 36 that are disposed on the lower face 34. The connectors 36 are described in detail later.

The housing 42 advantageously includes an internal shoulder 45 configured to cooperate with a complementary shoulder 35 formed on the complementary module 30 so as to close the housing 42 in airtight manner when the complementary module 40 is assembled to the housing 42. The complementary shoulder 35 is formed on a peripheral wall of the mounting portion 32A.

This prevents air leaking through the connection assembly 10, which contributes to the comfortable warmth of persons present in the building. A sealing element such as a gasket Is optionally provided on one and/or or the other of the shoulders 45 and 35, for example an elastomer gasket. The sealing element is not represented. The sealing element is advantageously manufactured by bi-injection with a housing of the complementary module 30.

The housing 42 also includes openings 46 each of which is designed to allow a respective connection device 100, 200 to pass through it when assembling the connection device 100, 200 to the housing 42. Here the housing 42 includes two openings 46.

The connection box 40 also includes an assembly piece 50 that forms the back 44 of the housing 42. As described in detail later, the assembly piece 50 is configured to retain each connection device 100, 200 in a connection configuration in which the wires of the multi-wire cable corresponding to this connection device 100, 200 are positioned in such a manner that the module 30 is able to cooperate with the connection devices 100 and 200.

In the example depicted here the assembly piece 50 is made in one piece with the rest of the housing 42. In a variant that is not represented the assembly piece 50 is a part attached to the rest of the housing 42, for example fixed to the rest of the housing by fixing means such as screws, or even clipped onto the rest of the housing 42. More generally, the assembly piece 50 is configured to form the back 44 of the connection box 40.

The connection device 100 represented in FIG. 3 is described next. This connection device 100 is designed to connect an electrical power cable, for example at a voltage greater than 100 volts. Here this power cable is represented by three wires 110, the three wires 110 including a live wire 110P, a neutral wire 110N and an earth wire 110T. The wires 110 are generally identified by different colours. The three wires 110 and more generally the multi-wire cables do not form part of the invention but serve to show the context of use thereof. Each wire 110 includes a metal conductive core, generally made of copper or copper alloy, that is received in an insulating sheath made of synthetic polymer. In the example depicted here the conductive core of each wire 110 consists of only a single strand. In a variant the conductive core comprises a plurality of strands that are received in the same insulative sheath.

The connection device 100 has a main portion 102 that forms a passage 104 configured to guide one end of the cable. The passage 104 is therefore configured to guide an end of each wire 110 of this cable. The passage 104 opens to the outside of the main portion 102 via two opposite openings, comprising a rear opening 105A and a front opening 105B. In the example depicted here the cable is inserted via the rear opening 105A and exits via the front opening 105B; in other words the cable emerges toward a front of the main portion 102.

The main portion 102 is advantageously configured to be fixed to one end of a protective sheath 112 of the cable, the passage 104 being arranged in line with the sheath 112. As for the cables, the sheath 112 does not form part of the invention but serves to specify the context of use thereof. In the example depicted here the sheath 112 is a ringed semi-rigid sheath that comprises rings 114. Thus the main portion 102 is configured to be fixed to an end of the ringed sheath 112 and to this end includes clipping members 105C that are configured to cooperate with the rings 114 of the sheath 112. Here the clipping members 105C are formed at the periphery of the rear opening 105A. When the main portion 102 is assembled to the sheath 112 the clipping members 105C are inserted in the sheath 112 and are deformed elastically to allow the passage of the sheath 112 and then, by elastic return, cooperate with the rings 114 in such a manner as to retain the sheath 112.

The passage 104 includes a main duct 106 which here is inserted between two secondary ducts 108A and 108B. Each main duct 106 or secondary duct 108A, 108B is configured to receive a respective wire 110 of the cable in such a manner as to guide that wire 110. The ends of the wires 110 are therefore separated from one another and easily identifiable.

When the cable comprises only two wires 110, for example when the cable does not include the earth wire 110T, a two-wire cable 110 of this kind can nevertheless be mounted on the connection device 100 comprising three ducts, namely the main duct 106 and the two secondary ducts 108A and 108B. In a variant the connection device 100 includes only one secondary duct in addition to the main duct 106.

The connection device 100 also includes a retaining portion 120 that is secured to the main portion 102 and is configured to position the end of the cable emerging from the opening of the main portion 102, here via the front opening 105B.

In the example depicted here the main portion 102 and the retaining portion 120 are two distinct elements that are assembled together in such a manner that the retaining portion 120 is articulated to rotate relative to the main portion 102 about a rotation axis A120. In FIGS. 3a) and 3b) the connection device 100 is represented in a so-called mounting configuration while in FIG. 3c) the connection device 100 is represented in a so-called “connection” configuration, the passage from the mounting configuration to the connection configuration being effected by rotation of the retaining portion 120 relative to the main portion 102 about the rotation axis A120. When the connection device 100 is in the connection configuration, respectively the mounting configuration, the retaining portion 120 is in a connection position, respectively a mounting position, relative to the main portion 102.

In a variant that is not represented the retaining portion 120 is simply fixed to the main portion with no freedom of movement relative to the main portion, the retaining portion 120 being fixed in a position connected to the main portion 102. In another variant that is not represented the retaining portion and the main portion are made in one piece, the retaining portion 120 then being immobile relative to the main portion 102 in the connection position.

As represented in FIG. 3b), when the retaining portion 120 is in the mounting position the retaining portion 120 does not prevent longitudinal movement of the cable in the passage 104. An installer can then, at will, adjust the position of the wires 110 relative to the connection device 100, in particular adjust a length of the wires 110 projecting from the main portion 102.

The retaining portion 120 comprises protrusions 122 that form between them a plurality of guide paths 124 each of which is configured to receive a respective wire 110 of the cable. When a wire 110 is received in the corresponding guide path 124 that wire 110 is retained in a predetermined position relative to the retaining portion 120. For example, the insulating sheath of this wire 110 is a tight fit in the corresponding guide path 124 with the result that this wire 110 is considered immobile relative to the retaining portion 120.

Each guide path 124 includes a connection portion 126. Here the connection portions 126 are rectilinear portions of the guide paths 124 each of which extends along an axis A126. The axes A126 of the connection portions 126 are parallel to the same connection plane P126 of the retaining portion 120.

The axes A126 of the connection portions 126 are preferably coplanar. In this embodiment of the connection device 100 the connection portions 126 are parallel to one another and are parallel to the main duct 106 when the retaining portion 120 is in the connection position.

In the example depicted here the retaining portion 120 includes a plurality of guide paths 124 each of which is associated with a respective duct 106 or 108A or 108B and which are arranged parallel to one another.

The connection portions 126 are spaced from one another in such a manner as to retain each wire 110 at a distance from the other wires 110 and to insulate electrically the wires 110 received in the connection portions 126 from one another. The connection portions 126 are arranged in such a manner as to allow access to each wire 110 received in the corresponding connection portion 126 in a connection direction D120, the connection directions D120 being orthogonal to the connection plane P126 and oriented in the same direction. In other words, all the wires 110 received in the connection portions 126 of the same retaining portion 120 are visible and physically accessible in the connection direction D120.

In the FIG. 3c) example the retaining portion 120 is in the connection position relative to the main portion 102 and each wire 110 is received in a respective connection portion 126. The connection portions 126 retain the wires 110 so that they can be connected to the complementary module 30. The connection direction D120 orthogonal to the back 44 of the housing 42 is situated towards the top of FIG. 3c) here.

In FIG. 4a) the connection device 100 is in the same configuration as in FIG. 3c). The connection device 100 is moved closer to the connection box 40 facing the opening 46 chosen by the installer and is then inserted in the connection box 40, positioning the connection device 100 against the assembly piece 50 so that the connection plane P126 is parallel to the back plane P44. The connection direction D120 is parallel to the engagement axis A44 and oriented away from the back 44 of the housing 42.

The assembly piece 50 includes at least one housing 52, each housing 52 being associated with a respective opening 46. Here the assembly piece 50 includes two housings 52, each housing 52 being configured to cooperate, in particular through complementarity of shape, with a respective connection device 100 in such a manner that the connection device 100 passing through a given opening 46 can be positioned only in a unique position relative to the assembly piece 50.

The main portion 102 of the connection device 100 advantageously includes protrusions 109, here of “U” shape, that cooperate with complementary notches 54 on the assembly piece, as depicted in FIG. 4b). During assembly of the connection device 100 onto the assembly piece 50 the protrusions 109 are received in the complementary notches 54, in particular clipped into the notches 54, in such a manner as to maintain the connection device 100 in position relative to the assembly piece 50.

Referring to FIG. 4b), once the protrusions 109 are received in the complementary notches 52 the connection device 100 is assembled to the assembly piece 50, forming the connection socket 20. The connection device 100 is held in the connection configuration. In particular, the connection direction D120 is maintained parallel to the engagement axis A44. The protrusions 109 and the complementary notches 54 are one non-limiting example of retaining members that are configured to cooperate, in particular through complementarity of shape, in such a manner as to retain this connection device 100 in position relative to the assembly piece 50.

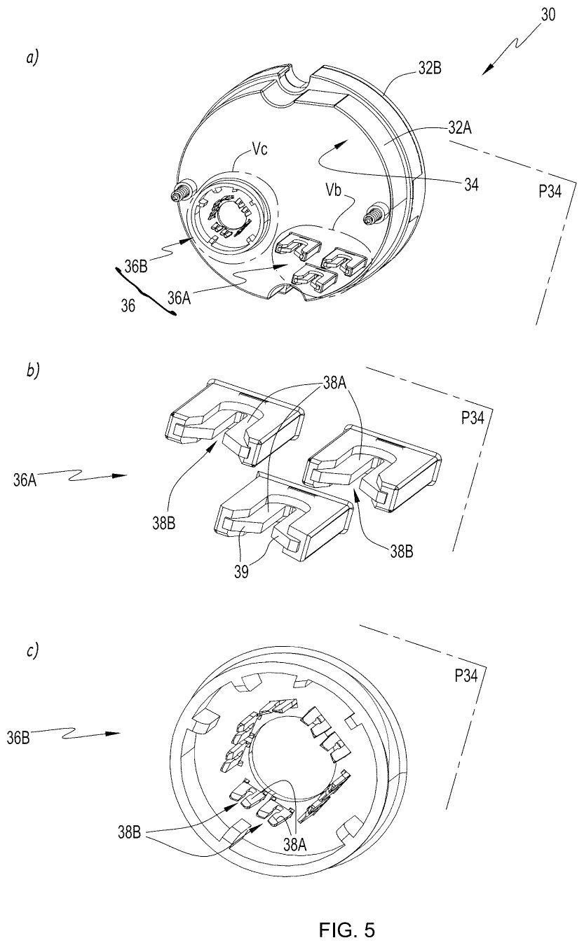

The principles of the connection of the complementary module 30 to the connection socket 20 are described next, in particular with reference to FIG. 5.

The connection device 100, held in the connection configuration by the assembly piece 50, is configured to cooperate with the complementary module 30 on moving the complementary module 30 of the connection device 100 in the connection movement parallel to the connection direction D120 in such a manner as to connect the complementary module 30 to each of the wires 110 received in the corresponding connection portion 126, the retaining portion 120 being in a connection position relative to the main portion 102. To be more precise, the connectors 36 disposed on the lower face 34 of the complementary module 30 are each configured to be connected to a respective wire 110 when that wire 110 is received in the connection portion 126 associated with that wire.

As depicted in FIG. 5a), here the connectors 36 include two different types of connector, namely first connectors 36A and second connectors 36B. The first connectors 36A are configured to cooperate with the connection device 100 of the first type described above and the second connectors 36B are configured to cooperate with the connection device 200 of the second type, which is described in detail later.

Generally speaking, each connector 36 is arranged in such a manner as to cooperate with a respective connection portion 126 when the complementary module 34 is inserted in the housing 42 by the connection movement so that, when a wire 110 is received in that connection portion 126, the corresponding connector 36 is electrically connected to that wire 110.

The connectors 36 are preferably insulation-displacement connectors, i.e. each connector 36 is configured to be connected to a wire 110 without having beforehand to expose the conductive core of that wire by removing part of the insulating sheath around the conductive core.

In the example depicted here each connector 36 includes a blade 38A that is made of metal, which is arranged on and projects from the lower face 34, and in which a slot 38B is formed. Each slot 38B extends orthogonally to the lower plane P34. For each connector 36 the slot 38B is designed to receive the conductive core of the wire 110 associated with that connector 36 in such a manner as to establish an electrical connection between the blade 38A and that wire 110. Here slot 38B has a flared end 39, with sharp, preferably cutting, edges, that are designed to cut the insulative sheath of the wire 110 when the wire 110 is inserted in the slot 38B.

During the movement of connection of the complementary module 30 to the connection socket 20, when a wire 110 is received in a connection portion 126, as the lower face 34 approaches the assembly piece 50, the connector 36 associated with that wire 110 moves toward that wire 110, and the flared end 39 centres the wire relative to the slot 38B and cuts the insulating sheath of that wire 110. The connection movement continuing, the conductive core of the wire 110 is received in the slot 38B, establishing the electrical contact with the blade 38A.

Referring to FIG. 5b), the first connectors 36A are three in number and each is configured to be connected to one of the wires 110P, 110N or 110T, each of which is received in their respective connection portion 126, the retaining portion 120 being itself retained by the assembly piece 50.

Referring to FIG. 5c), here the second connectors 36B are nine in number, including eight blades 38A associates in pairs and a ninth blade 38A. The blades 38A of the same pair are aligned with one another, the four pairs of blades 38A and the ninth blade 38A therefore forming groups which here are arranged in a pentagonal shape.

The connection device 200 corresponding to the second embodiment of the invention is described next with reference to FIGS. 6 and 7. In the second embodiment elements analogous to those of the first embodiment bear the same references and function in the same manner. There are mainly described hereinafter the differences between the first and second embodiments.

One of the main differences of the second embodiment compared to the first embodiment is that the connection device 200 conforming to the second embodiment of the invention is configured to be connected to an Ethernet-type cable that here comprises four twisted wire pairs 210, i.e. eight wires, and an earth, ninth wire 210, the nine wires 210 being received in a flexible sheath 211. The flexible sheath 211 advantageously incorporates a metal screen, in particular an aluminium tape, which forms a screen against electromagnetic interference, the earth, ninth wire 210 forming a drain wire for this screen. In FIGS. 6 and 7a) the flexible sheath 211 conceals the wires 210 of the Ethernet cable whereas in FIGS. 7b) and 7c) the flexible sheath 211 is not represented and only the wires 210 of the Ethernet cable can be seen.

The connection device 200 is represented on its own in FIG. 6a). The connection device 200 comprises the main portion 102 and a retaining portion 220.

The main portion 102 provides the passage 104 which here includes only the main duct 106, which is configured to allow the Ethernet cable to pass through it, in order to allow it to pass through it the flexible sheath 211 covering the wires 210, as represented in FIG. 7a).

Here the retaining portion 220 is a distinct portion of the main portion 102 and is articulated to rotate relative to the main portion 102 about the rotation axis A120. In FIGS. 6a) and 6b) the connection device 200 is represented in the mounting configuration and in FIGS. 6c) and 7a) the connection device 200 is represented in the connection configuration.

The retaining portion 220 has a cylindrical shape that extends along a central axis A220 and here has a globally pentagonal section. Here the central axis A220 is radial relative to the rotation axis A120. The retaining portion 220 has a front face 222 that is oriented away from the main portion 102 when the retaining portion 220 is in the mounting position. Here the front face 222 is globally pentagonal and extends in a front plane P222 that is orthogonal to the central axis A220.

A central orifice 223 is formed through the main portion 220 and opens onto the front face 222. The central orifice 223 is centred on the central axis A220 and aligned with the main duct 106 when the retaining portion 220 is in the mounted position. In other words, the central orifice 223 extends the main duct 106 when the retaining portion 220 is in the mounting position. This facilitates insertion of the Ethernet cable through the connection device 200 with no risk of disrupting the organisation of the wires 110 received in the flexible sheath 211 and of damaging those same wires 110, which would degrade the quality of the signal transmitted during use of the Ethernet cable.

Here the passage from the mounting position to the connection position is effected by causing the retaining portion 220 to pivot 90° about the rotation axis A120. When the connection device 200 is in the connection position and is received in one of the housings 52 of the assembly piece 50, the front plane P222 is parallel to the back plane P44, the front face 222 being oriented away from the back 44.

The connection device 200 advantageously includes indexing members that are configured to retain the connection device 200 in the connection configuration. The indexing members are not represented. For example, the main portion 102 includes a lug and the retaining portion 220 includes a notch of complementary shape to the lug, the lug and the notch cooperating with one another in such a manner as to form the indexing members.

When the retaining portion 220 is in the connection position the central orifice 223 is at an angle, preferably a right angle, to the main duct 106 and the Ethernet cable passing through the connection device 200 is bent. A radius of curvature R220 of the Ethernet cable is defined as a radius of curvature of the flexible sheath 211 measured at the level of the bend. The central orifice 223 and the main duct 106 are arranged in such a manner as to guide the cable received in the main duct 106 and the central orifice 223. Thanks to the connection device 100 the Ethernet cable is therefore bent in a reproducible manner and with no risk of crushing of the Ethernet cable potentially caused by poor manipulation by the installer, which would degrade the quality of the signal transmitted. This reproducibility of the radius of curvature R220 assures protection of the screens of the Ethernet cable. The radius of curvature R220 is preferably greater than 3 mm so as not to crush the Ethernet cable when fitting the connection device 100.

When the retaining portion 220 is in the connection position the rubbing of the sheath 211 on the walls of the main duct 106 and/or of the central orifice 223 advantageously prevents movement of the Ethernet cable along the main duct 106.

The retaining portion 220 includes guide paths 224 that here are recessed into the front face 222. Each guide path 224 is configured to receive a respective wire 210 of the cable so as to retain the corresponding wire 210 in a predetermined position relative to the retaining portion 220. Here the retaining portion 220 includes nine guide paths 224, comprising eight guide paths 224 associated in pairs and a ninth guide path 224. The pairs of guide paths 224 are each associated with a twisted pair of wires 210 of the Ethernet cable and the ninth guide path 224 is associated with the ninth or drain wire 210 of the screen of the Ethernet cable.

Each guide path 224 includes a connection portion 226 that extends parallel to the front plane P222 of the retaining portion 220. The connection portions 226 are preferably arranged radially relative to the central axis A220 of the central orifice 223.

Each connection portion 226 includes notches 227 designed to guide the blades 38A—cf. FIG. 5—of the second connectors 36B.

It is clear that each blade 38A is inserted in a respective notch 227 by a movement orthogonal to the front plane P222. In other words, when the retaining portion 220 is in the connection position the front plane P222 is the connection plane.

The connection device 200 advantageously also includes an organiser 240 that is configured to be assembled onto the retaining portion 220 so as to assist an installer to distinguish the guide paths 224 from one another. In the example depicted here the organiser 240 is glued to a rear face 241 of the retaining portion 220, the rear face 241 being opposite the front face 222. Here the organiser 240 is a sticker that is advantageously made of a flexible material, the organiser 240 being designed to remain in place, fixed to the retaining portion 220, when the connection device 200 is received in the housing 42. The organiser 240 is folded to take up its place between the flanks of the retaining portion 220 and the walls of the housing 52. The organiser 240 therefore remains available to the installer at all times to enable verification of the correct positioning of the wires of the Ethernet cable, as explained later.

In a variant that is not represented the organiser is made of a rigid material and clipped onto the rear face 241 of the retaining portion 220, for example by means of a clipping system such as a pin/notch assembly or the like.

In a variant that is not represented the organiser 240 is made in one piece with the retaining portion 220. The organiser 240 is then preferably adapted to be cut, i.e. the organiser 240 is designed to be separated from the retaining portion 220, for example by hand or using a simple tool such as pliers or similar, in particular side cutters.

Here the organiser 240 is in the shape of flower, with portions 242 in the shape of petals each of which extends radially relative to the central axis A220. Each petal 242 is advantageously aligned along the main axis A220 with a respective guide path 224. In accordance with the connection standards EIA TIA 568 A and/or B—that apply in particular to connecting so-called “RJ45” connectors—each wire 210 of the Ethernet cable is associated with a unique colour code, for example blue, blue-white stripes, green, green-white stripes, etc. Each petal 242 advantageously bears a colour and/or alphanumeric code that is associated in a non-equivocal manner with one of the wires 210 of the Ethernet cable. Each petal 242 preferably bears a colour code identical to the colour code of the corresponding wire 210, that colour code complying with the connection standard EIA TIA 568 A or B. Here the organiser 240 includes eight petals 242 each associated with a wire 110 that is part of a twisted pair, while no petal 242 is associated with the ninth or screen drain wire 110.

As depicted in FIG. 7c), thanks to the organiser 240 the installer can easily recognise which of the wires 210 they have to place in which guide path 224, reducing the risk of errors. The radial arrangement of the connection portions 226 relative to the central axis A220 gives the installer a clear view of the wires 210 and the guide portions 226. This operation of placing the wires 210 is particularly rapid and easy, in particular because it is not necessary to strip each wire 210 for their subsequent connection to the complementary module 30, the latter include insulation-displacement connectors 36.

Once each wire 210 is received in the corresponding guide path 224 the installer can insert the connection device 200 in the housing 42 through an unobstructed opening 46, as represented in FIG. 2b).

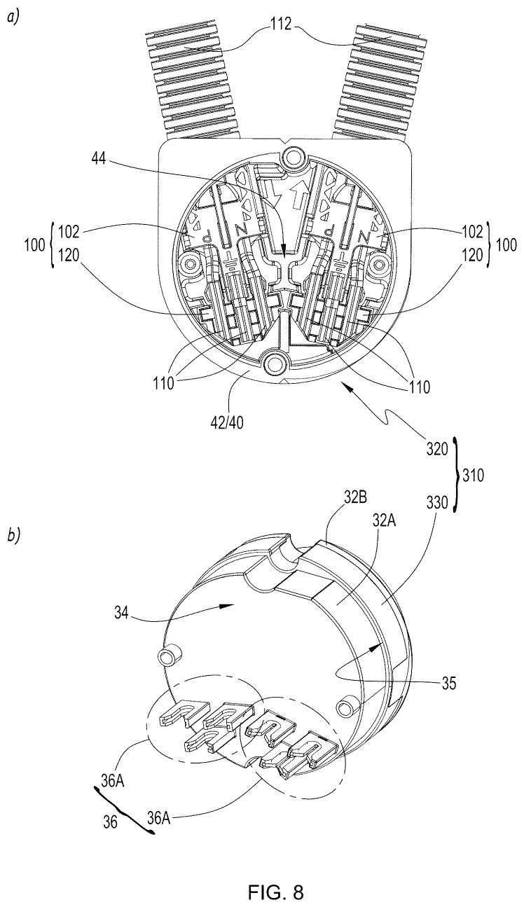

A connection assembly 310 conforming to another embodiment of the invention is represented in FIG. 8. Compared to the connection assembly 10 described above the connection assembly 310 includes a connection socket 320 with an electrical connection box 40 to which are connected two connection devices 100 of the first type, that is to say designed for the connection of an electrical power cable comprising three wires 110. The two connection devices 100 are preferably identical to one another.

The connection assembly 310 is a complementary module 330 on which are disposed two connectors 36 of the same type as the first connectors 36A, each of the first connectors 36A being configured to be connected to a respected connection device 100 of the first type.

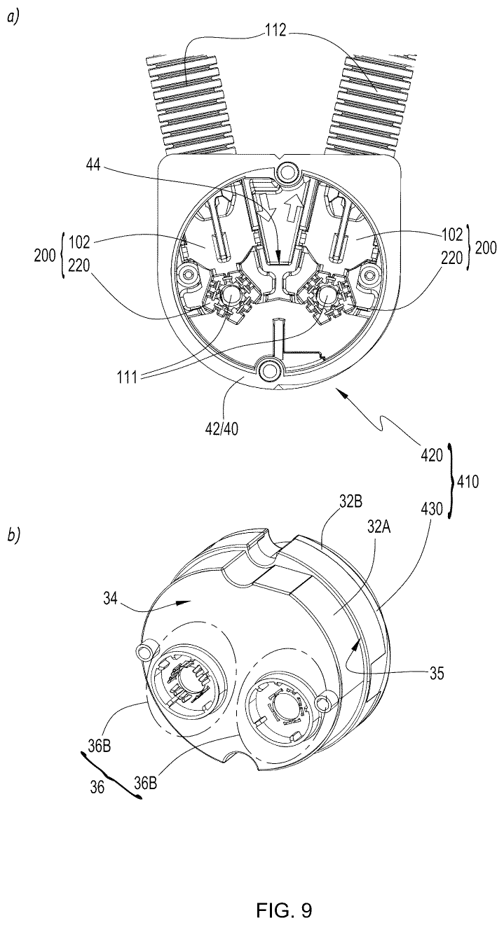

A connection assembly 410 conforming to another embodiment of the invention is represented in FIG. 9. Compared to the connection assembly 310 described above, the connection assembly 410 includes a connection socket 420 with an electrical connection box 40 to which two connection devices 200 conforming to the second embodiment are connected, i.e. two connection devices 200 of the second type, designed for connection of an Ethernet cable with nine wires 210. The two connection devices 200 are preferably identical to one another.

The connection assembly 410 includes a complementary module 430 on which are disposed two connectors 36 of the same type as the second connectors 36B, each of the second connectors 36B being configured to be connected to a respective connection device 200 of the second type.

It is clear that multiple configurations are possible, the same type of housing 42 being compatible with connection devices 100 of the first type or connection devices 200 of the second type. As a corollary of this, a plurality of kinds of complementary modules are also possible.

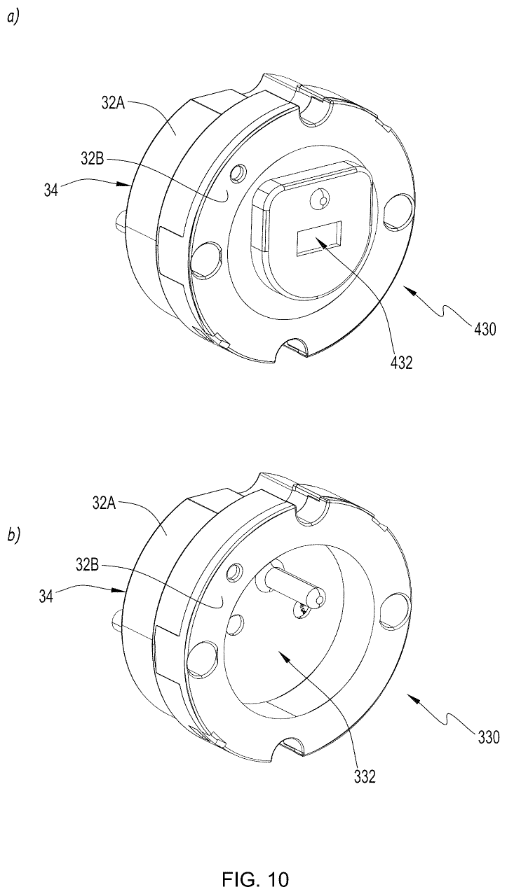

Referring to FIG. 10a), here the complementary module 430 includes a socket 432, for example an RJ45 type female socket. In some so-called power over Ethernet (POE) configurations the Ethernet cables enable transmission of electrical power of up to several tens of watts. Instead of this or in addition to this the complementary module 430 includes a wireless communication device, for example a Wi-Fi, Bluetooth or Zigbee access point. Alternatively, the socket 432 is a USB socket, for example for charging a mobile device such as a smartphone.

Referring to FIG. 10b), the complementary module 330 described above includes on a front face an electrical socket 332. The format of the socket is not limiting on the invention.

More generally, as a function of the combination of the types of cable (power or Ethernet) connected to the housing 42 it is possible to propose complementary modules offering multiple functionalities.

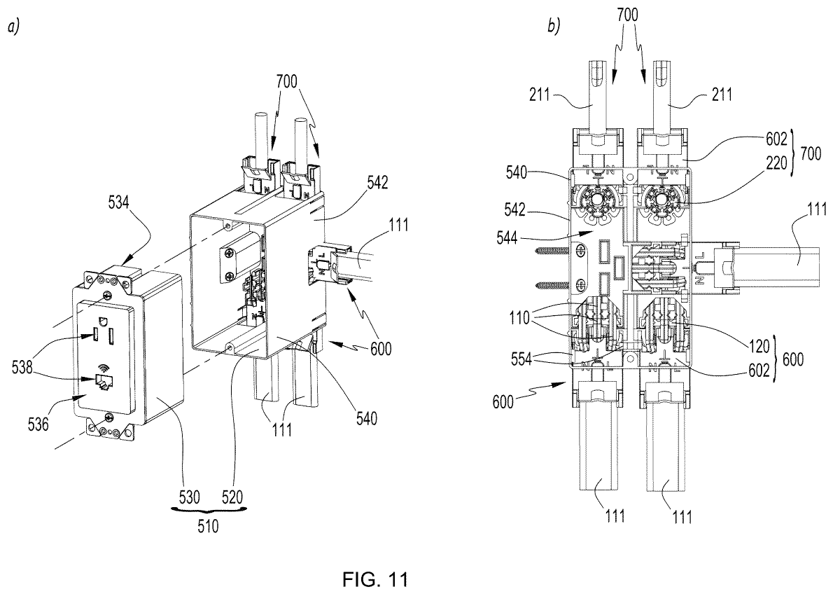

A connection assembly 510 conforming to another embodiment of the invention is represented in FIG. 11.

The connection assembly 510 includes a connection socket 520 and a complementary module 530. The complementary module 520 is represented in the connection configuration at a distance from the connection socket 520.

Here the complementary module 530 has a globally parallelepipedal shape with an interior face 534 that is oriented toward the connection socket 520 and a front face 536 that is oriented away from the interior face 534. Here the front face 536 includes two female connectors 538, here comprising an RJ45 connector and a power connector, here in the North-American format.

The connection socket 520 includes a connection box 540 that includes a housing 542 to which are connected a plurality of connection devices, here five in number. In the example depicted here the connection devices are of two different types, including a connection device 600 of the first type, which is configured to be connected to three power wires 110, and a connection device 700 of the second type, which is configured for the connection of Ethernet cables. In the example depicted here the connection socket 520 includes two connection devices 700 of the second type, situated at the top in FIG. 11b), and three connection devices 600 of the first type.

Each connection device 600, 700 has a main portion 602 and a retaining portion 120 or 220 that is analogous, preferably identical, to the retaining portions described with reference to the previous embodiments.

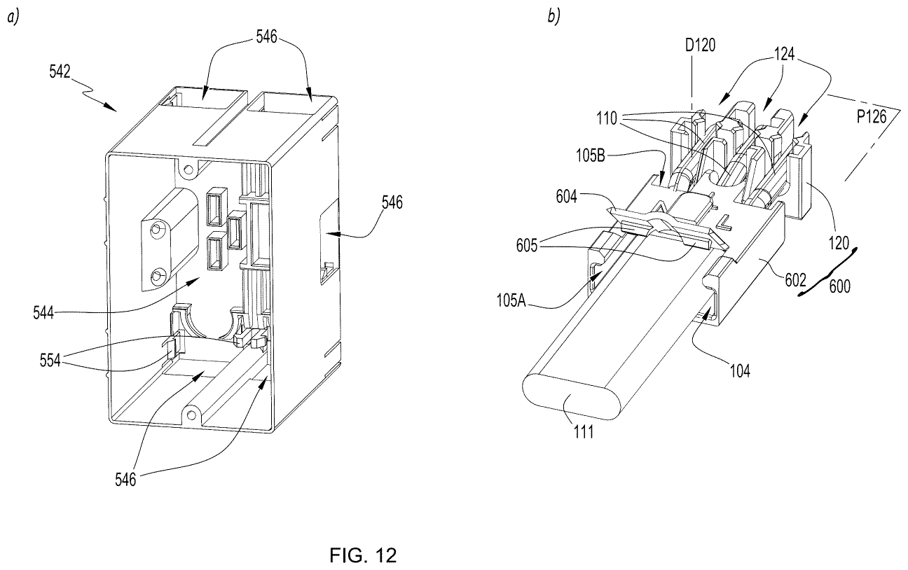

Referring to FIG. 12a), the housing 542 has a globally parallelepipedal shape with five openings 546 each of which is designed to allow a respective connection device 600, 700 to pass through it when assembling this connection device onto the housing 542. The housing 542 has a back 544 that forms housings 552 for receiving connection devices 600 or 700.

In the example depicted here the housing 542 includes clips 554 that are designed to cooperate with the body 602 of each connection device 600, 700 in such a manner as to retain the connection device 600, 700 in position relative to the back 544, in particular to retain the connection device 600, 700 in the connection configuration.

Referring to FIG. 12b), the three wires 110 are partly received in a protective sheath 111 that here has an oblong shape. The sheath 111 is cut to the required length and enters the passage 104 via the rear opening 105A, the wires 110 exiting via the front opening 105B.

The main portion 602 advantageously includes a plate 604 that is articulated to rotate relative to the rest of the body 602 and includes lugs 605 that are configured to clamp the cable, here the sheath 111, when the cable is received in the passage 104 so as to prevent movement of the cable along the passage 104. The plate 604 is one example of a cable immobilising device.

The embodiments and the variants referred to hereinabove may be combined with one another to generate new embodiments of the invention.

1. A connection device for connecting a multi-wire electrical cable to a complementary module, wherein the connection device includes:
a main portion that forms a passage configured to guide an end of the cable, the passage including a main duct that opens to the outside of the main portion,
a retaining portion that is secured to the main portion and configured to position the end of the cable emerging from the passage,
wherein:
the retaining portion includes one or more guide paths each of which is configured to receive a respective wire of the cable in such a manner as to retain the corresponding wire in a predetermined position relative to the retaining portion,
each guide path includes a connection portion that extends parallel to the same connection plane as the retaining portion,
the connection portions are arranged in such a manner as to allow access to each wire received in the corresponding connection portion in a connection direction orthogonal to the connection plane,
the connection device is configured to cooperate with the complementary module by moving the complementary module of the connection device closer by a connection movement parallel to the connection direction, in such a manner as to connect the complementary module to each of the wires received in the corresponding connection portion, the retaining portion being in a connection position relative the main portion.

2. The connection device according to claim 1 wherein:
each connection portion is configured to cooperate with a respective connector of the complementary module, in particular an insulation-displacement connector, in such a manner as to connect electrically each wire received in the corresponding connection portion to the corresponding complementary connector by movement in translation in the connection direction.

3. The connection device according to claim 1, wherein:
the main portion includes an immobilising device that is configured to clamp the cable when the cable is received in the passage in such a manner as to prevent movement of the cable along the passage.

4. The connection device according to claim 1, wherein:
the main portion is configured to be fixed to one end of a protective sheath of the cable, the passage being in line with the sheath.

5. The connection device according to claim 4 wherein:
the main portion is configured to be fixed to one end of a ringed sheath comprising rings,
the main portion includes clipping members that are configured to cooperate with the rings of the sheath in such a manner as to fix the main portion to the sheath.

6. The connection device according to claim 1 wherein the retaining portion is mobile in rotation relative to the main portion between:
a mounting position wherein the retaining portion does not prevent longitudinal movement of the cable in the passage, and
the connection position wherein the connection portions are able to retain each wire in order to connect each wire to the complementary module.

7. The connection device according to claim 6, wherein:
the main duct is configured to receive a cable comprising four pairs of wires, in particular a cable of Ethernet type as defined in the standard IEEE 802.3,
the retaining portion includes a central orifice that extends the main duct when the retaining portion is in the mounting position and that is at an angle to the main duct when the retaining portion is in the connection position so as to guide the cable received in the main duct and the central orifice with a radius of curvature greater than 3 mm.

8. The connection device according to claim 7 wherein:
the connection portions are arranged radially relative to a central axis of the central orifice.

9. The connection device according to claim 1 wherein:
the passage includes, in addition to the main duct, at least one secondary duct, each main or secondary duct being configured to receive a respective wire of the cable,
the retaining portion includes a plurality of guide paths each of which is associated with a respective duct and that are arranged parallel to one another,
the connection portions are parallel to the main duct when the retaining portion is in the connection position.

10. An assembly piece configured to form a back of an electrical connection box, the assembly piece including:
at least one housing, the or each housing being configured to cooperate, in particular by complementarity of shape, with a respective connection device, each connection device conforming to claim 1, so as to retain each connection device in the connection configuration.

11. The assembly piece according to claim 10 further including retaining members that are configured to cooperate, in particular by complementarity of shape, with the main portion of each connection device so as to retain that connection device in position relative to the assembly piece.

12. An electrical connection box including a housing configured to be fixed to a partition and an assembly piece according to claim 10, the assembly piece forming a back of the housing.

13. The electrical connection box according to claim 12 wherein:
the assembly piece is attached to the rest of the housing.

14. The electrical connection box according to claim 12 wherein:
the assembly piece is made in one piece with the rest of the housing.

15. A connection socket including:
at least one connection device according to claim 1;
an electrical connection box including a housing configured to be fixed to a partition and an assembly piece configured to form a back of the electrical connection box, the assembly piece including at least one housing, the or each housing being configured to cooperate, in particular by complementarity of shape, with a respective connection device, so as to retain each connection device in the connection configuration, the assembly piece forming a back of the housing, and
each at least one connection device being associated with a respective housing of the assembly piece,
wherein:
each retaining portion is received in a respective housing of the assembly piece, each connection device being retained in the connection configuration,
the connection direction is orthogonal to the back of the housing.

16. A complimentary module configured to be assembled onto a connection socket according to claim 15, wherein:
the complementary module includes a mounting portion configured to be inserted in the housing in a movement in translation orthogonal to the back of the housing,
the mounting portion has a lower face on which are disposed connectors,
each connector is arranged in such a manner as to cooperate with a respective connection portion when the complementary module is inserted in the housing by the movement in translation so that when a wire is received in that connection portion the corresponding connector is electrically connected to that wire.

17. An electrical connection assembly including:
a connection socket according to claim 15,
a complementary module configured to be assembled onto the connection socket wherein:
the complementary module includes a mounting portion configured to be inserted in the housing in a movement in translation orthogonal to the back of the housing,
the mounting portion has a lower face on which are disposed connectors,
each connector is arranged in such a manner as to cooperate with a respective connection portion when the complementary module is inserted in the housing by the movement in translation so that when a wire is received in that connection portion the corresponding connector is electrically connected to that wire,
wherein:
the complementary module is inserted in the connection socket.

18. The assembly piece according to claim 10, wherein the assembly piece includes two housings.

19. The complimentary module according to claim 16, wherein the connectors disposed on the lower face of the mounting portion are insulation-displacement connectors.
